(19) United States
(12) Patent Application Publication
(10) Pub. No.: US 2012/0295017 A1
(43) Pub. Date: Nov. 22, 2012

(54) METHOD FOR PRODUCING PLASMA DISPLAY PANEL

(76) Inventors: Kazuo Uetani, Hyogo (JP); Koyo Sakamoto, Osaka (JP); Kaname Mizokami, Kyoto (JP); Shinsuke Yoshida, Osaka (JP)

(21) Appl. No.: 13/574,519

(22) PCT Filed: Dec. 27, 2010
(86) PCT No.: PCT/JP2010/007542

§ 371 Date: Jul. 20, 2012

(30) Foreign Application Priority Data
Jan. 22, 2010 (JP) 2010-011616

(51) Int. Cl. B05D 7/24

(52) U.S. Cl. 427/126.3

(57) ABSTRACT

An aggregated particle paste containing aggregated particles, each composed of a plurality of aggregated crystal particles made of magnesium oxide, and a solvent is prepared. A crystal particle paste containing crystal particles having a cubic shape, made of magnesium oxide, and a solvent is prepared. Thereafter, by mixing the aggregated particle paste and the crystal particle paste with each other, a mixed crystal particle paste is prepared. Then, by applying the mixed crystal particle paste to the base layer, a mixed crystal particle paste film is formed thereon. Thereafter, by drying the mixed crystal particle paste film, the aggregated particles and crystal particles are dispersed over the entire surface of the base layer.

### TECHNICAL FIELD

A technique disclosed herein relates to a method for manufacturing a plasma display panel to be used in a display device or the like.

### BACKGROUND ART

A plasma display panel (hereinafter, referred to as a PDP) has a front plate and a rear plate. The front plate has a glass substrate, a display electrode formed on one main surface of the glass substrate, a dielectric layer to cover the display electrode and function as a capacitor, and a protective layer made of magnesium oxide (MgO) formed on the dielectric layer. On the other hand, the rear plate has a glass substrate, an address electrode formed on one main surface of the glass substrate, an base dielectric layer to cover the address electrode, a barrier rib formed on the base dielectric layer, and phosphor layers formed between the barrier ribs and emitting red, green and blue light, respectively.

The front plate and the rear plate are air-tightly sealed with each other, with their electrode forming sides being opposed to each other. A discharge gas of neon (Ne) and xenon (Xe) is sealed in a discharge space partitioned by a barrier rib. The discharge gas is allowed to cause a discharge by a video signal voltage selectively applied to a display electrode. Ultraviolet rays generated by a discharge excite the phosphor layers having respective colors. The excited phosphor layers emit red, green and blue light. A PDP achieves a color image display in this manner (see Patent Literature 1).

The protective layer has main four functions. The first function is to protect the dielectric layer against ion impacts caused by a discharge. The second function is to emit an initial electron to generate an address discharge. The third function is to retain electric charges to generate a discharge. The fourth function is to emit secondary electrons in a sustain discharge. By protecting the dielectric layer against the ion impacts, an increase in discharge voltage is suppressed. By increasing the number of initial electron emission, an address discharge error, which causes flickering on an image, can be reduced. By improving the electric charge retention performance, an applied voltage can be reduced. By increasing the number of secondary electron emission, a sustain discharge voltage is reduced. In order to increase the number of initial electron emission, for example, an attempt has been made in which silicon (Si) or aluminum (Al) is added to MgO in the protective layer.

However, when initial electron emission performance is improved by mixing an impurity in MgO, an attenuation rate at which electric charges accumulated in the protective layer is reduced with time becomes greater. Consequently, a countermeasure that increases an applied voltage is necessary in order to compensate for the attenuated electric charges. The protective layer is required to simultaneously have two contradictory characteristics, that is, high initial electron emission performance and a reduced attenuation rate of electric charges, i.e., high electric charge retention performance.

### CITATION LIST

### Patent Literature

PTL1: Unexamined Japanese Patent Publication No. 2003-128430

### SUMMARY OF THE INVENTION

The technique relates to a method for manufacturing a PDP provided with a dielectric layer covering display electrodes and a base layer formed on the dielectric layer. An aggregated particle paste containing aggregated particles, each composed of a plurality of aggregated crystal particles made of magnesium oxide, and a solvent is prepared. A crystal particle paste containing crystal particles having a cubic shape, made of magnesium oxide, and a solvent is prepared. Thereafter, by mixing the aggregated particle paste and the crystal particle paste with each other, a mixed crystal particle paste is prepared. Then, by applying the mixed crystal particle paste, a mixed crystal particle paste film is formed on the base layer. Thereafter, by drying the mixed crystal particle paste film, the aggregated particles and crystal particles are dispersed over the entire surface of the base layer.

### BRIEF DESCRIPTION OF DRAWINGS

FIG. 1 is a perspective view illustrating a structure of a PDP.

FIG. 2 is an electrode arrangement view of a PDP.

FIG. 3 is a block circuit diagram of a plasma display device.

FIG. 4 is a drive voltage waveform chart of a plasma display device.

FIG. 5 is a cross-sectional view illustrating a configuration of a front plate of a PDP according to an exemplary embodiment.

FIG. 6 is an enlarged view illustrating a protective layer portion of the PDP.

FIG. 7 is a schematic view illustrating a particle structure of a surface of the protective layer.

FIG. 8 is an enlarged view for explaining aggregated particles.

FIG. 9 is a characteristic graph showing the results of cathode luminescence measurements of crystal particles.

FIG. 10 is a characteristic view graph showing the results of an examination between electron emission performance and a Vscn lighting voltage in a PDP.

FIG. 11 is a graph showing a relation between a Si concentration in a base film and a Vscn lighting voltage under an environment of 70° C. serving as a charge retention characteristic of a PDP.

FIG. 12 is a characteristic graph showing a relation between a lighting time and electron emission performance of a PDP.

FIG. 13 is an enlarged view for explaining a coverage.

FIG. 14 is a characteristic graph showing sustain discharge voltages in comparison with each other.

FIG. 15 is a characteristic graph showing a relation between an average particle diameter of aggregated particles and electron emission performance.

FIG. 16 is a characteristic graph showing a relation between a particle diameter of a crystal particle and a rate of occurrence of damages to a barrier rib.

FIG. 17 is a step diagram showing steps in forming a protective layer according to an exemplary embodiment.

FIG. 18 is a characteristic graph showing a relation between a pulse width of a pulse voltage applied to a data electrode and an address discharge failure rate.

### DESCRIPTION OF EMBODIMENTS

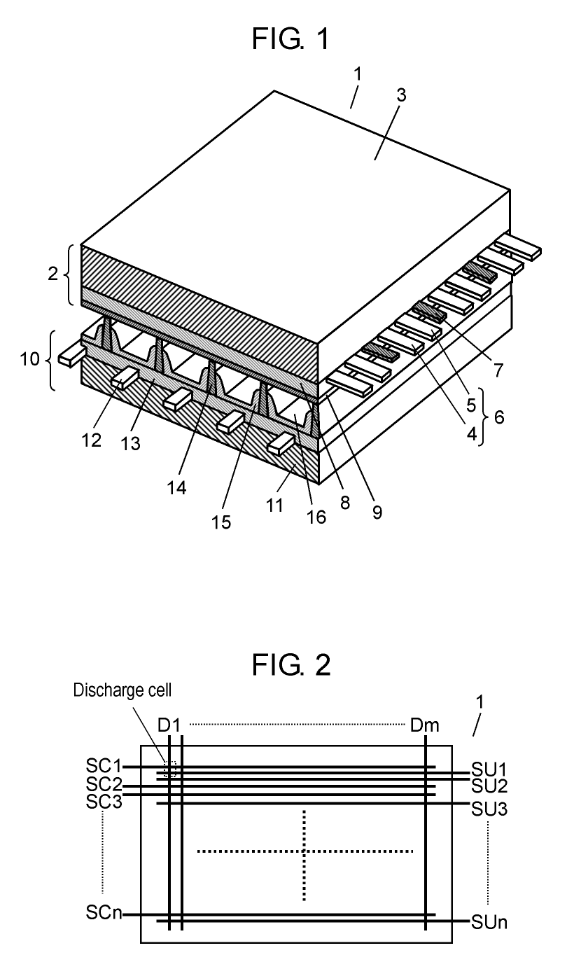

A basic structure of a PDP is a general alternating current surface discharge type PDP. As shown in FIG. 1, PDP 1 is provided in such a manner that front plate 2 including front glass substrate 3 and the like, and rear plate 10 including rear glass substrate 11 and the like are arranged so as to be opposed to each other. Front plate 2 and rear plate 10 are sealed in an air-tight manner by a sealing material made of glass frit or the like on their peripheral portions. A discharge gas such as neon (Ne) and xenon (Xe) is sealed at a pressure of 53 kPa (400 Torr) to 80 kPa (600 Torr) in discharge space 16 provided in sealed PDP 1.

On front glass substrate 3, a plurality of rows of paired belt-shaped display electrodes 6, each composed of scan electrode 4 and sustain electrode 5, and black stripes 7 are arranged in parallel with each other. Dielectric layer 8 serving as a capacitor is formed on front glass substrate 3 so as to cover display electrodes 6 and black stripes 7. Moreover, protective layer 9 composed of magnesium oxide (MgO) or the like is formed on a surface of dielectric layer 8.

Each of scan electrode 4 and sustain electrode 5 has a structure in which a bus electrode composed of Ag is stacked on a transparent electrode composed of a conductive metal oxide such as an indium tin oxide (ITO), a tin oxide (SnO₂), or a zinc oxide (ZnO).

On rear glass substrate 11, a plurality of data electrodes 12 each composed of a conductive material mainly containing silver (Ag) is arranged in parallel with each other in a direction orthogonal to display electrodes 6. Data electrode 12 is covered with base dielectric layer 13. Moreover, on base dielectric layer 13 between data electrodes 12, barrier rib 14 having a predetermined height is formed to section discharge space 16. In a groove between barrier ribs 14, phosphor layer 15 emitting red light by ultraviolet rays, phosphor layer 15 emitting green light thereby and phosphor layer 15 emitting blue light thereby are sequentially applied and formed for each of data electrodes 12. A discharge cells is formed at a position in which display electrode 6 and data electrode 12 intersect with each other. The discharge cell having phosphor layers 15 of red, green and blue colors aligned in a direction along discharge electrode 6 serves as a pixel for a color display.

Additionally, in the present exemplary embodiment, the discharge gas sealed in discharge space 16 contains 10% by volume or more and 30% by volume or less of Xe.

As shown in FIG. 2, PDP 1 has n-number of scan electrodes SC1, SC2, SC3 . . . SCn (indicated by 4 in FIG. 1) arranged so as to extend in a longitudinal direction. PDP 1 has n-number of sustain electrodes SU1, SU2, SU3 . . . SUn (indicated by 5 in FIG. 1) arranged so as to extend in a longitudinal direction. PDP 1 has m-number of data electrodes D1 . . . Dm (indicated by 12 in FIG. 1) arranged so as to extend in a latitudinal direction. The discharge cell is formed at a portion in which paired scan electrode SC1 and sustain electrode SU1 intersect with one data electrode D1. Thus, m×n-number of discharge cells is formed in the discharge space. Each of the scan electrode and the sustain electrode is connected to a connection terminal provided in a peripheral end portion of the front plate outside an image display region. The data electrode is connected to a connection terminal provided in a peripheral end portion of the rear plate outside an image display region.

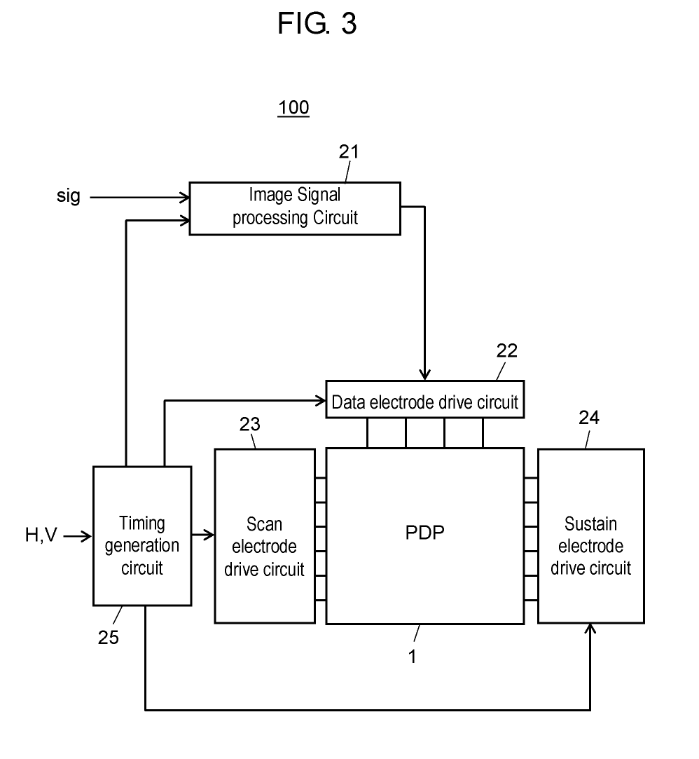

As shown in FIG. 3, plasma display device 100 has PDP 1, image signal processing circuit 21, data electrode drive circuit 22, scan electrode drive circuit 23, sustain electrode drive circuit 24, timing generation circuit 25 and a power supply circuit (not shown).

Image signal processing circuit 21 converts an image signal sig into image data with respect to each sub-field. Data electrode drive circuit 22 converts the image data with respect to each sub-field into signals corresponding to data electrodes D1 to Dm and drives respective data electrodes D1 to Dm. Based on horizontal synchronizing signal H and vertical synchronizing signal V, timing generation circuit 25 generates various timing signals and supplies them to respective drive circuit blocks. Based on the timing signal, scan electrode drive circuit 23 supplies a drive voltage waveform to each of scan electrodes SC1 to SCn. Based on the timing signal, sustain electrode drive circuit 24 supplies a drive voltage waveform to each of sustain electrodes SU1 to SUn.

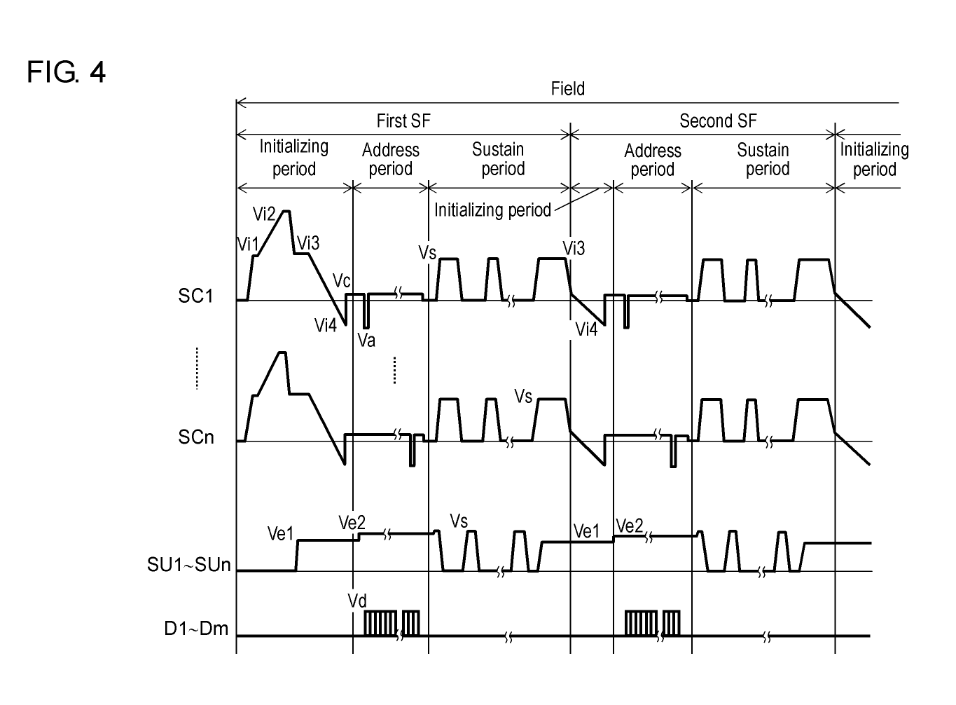

Then, with reference to FIG. 4, the following description will discuss a drive voltage waveform to drive PDP 1 and operations thereof.

As shown in FIG. 4, plasma display device 100 in the present exemplary embodiment has one field including a plurality of sub-fields. The sub-field has an initializing period, an address period and a sustain period. The initializing period is a period in which an initializing discharge is generated in the discharge cell. The address period is a period in which after the initializing period, an address discharge for selecting the discharge cell which emits light is generated. The sustain period is a period in which a sustain discharge is generated in the discharge cell selected in the address period.

In the initializing period of the first sub-field, data electrodes D1 to Dm and sustain electrodes SU1 to SUn are retained at 0 (V). Moreover, a ramp voltage gradually rising from voltage Vi1 (V) that is a discharge start voltage or lower to voltage Vi2 (V) that exceeds the discharge start voltage is applied to scan electrodes SC1 to SCn. Then, in all of the discharge cells, a first weak initializing discharge is generated. By the initializing discharge, a negative wall voltage is accumulated on scan electrodes SC1 to SCn. A positive wall voltage is accumulated on sustain electrodes SU1 to SUn as well as on data electrodes D1 to Dm. The wall voltage is a voltage generated by wall electric charges accumulated on protective layer 9, phosphor layer 15, and the like.

Thereafter, sustain electrodes SU1 to SUn are retained at positive voltage Ve1 (V), a ramp voltage that gradually falls from voltage Vi3 (V) to voltage Vi4 (V) is applied to scan electrodes SC1 to SCn. Thus, in all of the discharge cells, a second weak initializing discharge is generated. The wall voltage between scan electrodes SC1 to SCn and sustain electrodes SU1 to SUn is weakened. The wall voltage on data electrodes D1 to Dm is adjusted to a value suitable for an address operation.

In the subsequent address period, scan electrodes SC1 to SCn are once retained at Vc (V). Sustain electrodes SU1 to SUn are retained at Vet (V). Then, negative scan pulse voltage Va (V) is applied to scan electrode SC1 in the first row, and further, positive address pulse voltage Vd (V) is applied to data electrodes Dk (k=1 to m) of discharge cells to be displayed on the first row of data electrodes D1 to Dm. At this time, a voltage at an intersection portion of data electrode Dk and scan electrode SC1 is obtained by adding the wall voltage on data electrode Dk and the wall voltage on scan electrode SC1 to externally applied voltage (Vd−Va) (V) so that the resulting voltage exceeds the discharge start voltage. Then, the address discharge is generated between data electrode Dk and scan electrode SC1, as well as between sustain electrode SU1 and scan electrode SC1. On scan electrode SC1 of the discharge cell with the address discharge generated therein, a positive wall voltage is accumulated. On sustain electrode SU1 of the discharge cell with the address discharge generated therein, a negative wall voltage is accumulated. On data electrode Dk of the discharge cell with the address discharge generated therein, a negative wall voltage is accumulated.

On the other hand, a voltage at intersection portions of data electrode D1 to Dm and scan electrode SC1 to which address pulse voltage Vd (V) has not been applied does not exceed the discharge start voltage. Therefore, the address discharge is not generated. The above-mentioned address operations are sequentially carried out until the discharge cell in an n-th row. The completion of the address period corresponds to the completion of the address operation in the discharge cell in the n-th row.

During the subsequent sustain period, positive sustain pulse voltage Vs (V) is applied as a first voltage to scan electrodes SC1 to SCn. A ground potential, that is, 0 (V) is applied as a second voltage to sustain electrodes SU1 to SUn. At this time, in the discharge cell in which the address discharge has been generated, a voltage between scan electrode SCi and sustain electrode SUi is a voltage obtained by adding the wall voltage on scan electrode SCi and the wall voltage on sustain electrode SUi to sustain pulse voltage Vs (V) so that the resulting voltage exceeds the discharge start voltage. Thus, the sustain discharge is generated between scan electrode SCi and sustain electrode SUi. The phosphor layer is excited and emits light by ultraviolet rays generated due to the sustain discharge. Thus, a negative wall voltage is accumulated on scan electrode SCi. A positive wall voltage is accumulated on sustain electrode SUi. A positive wall voltage is accumulated on data electrode Dk.

In the discharge cell in which the address discharge has not been generated during the address period, the sustain discharge is not generated. Therefore, the wall voltage at the time of the completion of the initializing period is retained. Subsequently, 0 (V) serving as the second voltage is applied to scan electrodes SC1 to SCn. Sustain pulse voltage Vs (V) serving as the first voltage is applied to sustain electrodes SU1 to SUn. Then, in the discharge cell in which the sustain discharge has been generated, the voltage between sustain electrode SUi and scan electrode SCi exceeds the discharge start voltage. Therefore, the sustain discharge is again generated between sustain electrode SUi and scan electrode SCi. That is, a negative wall voltage is accumulated on sustain electrode SUi. A positive wall voltage is accumulated on scan electrode SCi.

In the same manner as described above, by alternately applying sustain pulse voltage Vs (V) the number of which corresponds to a luminance weight to scan electrodes SC1 to SCn and sustain electrodes SU1 to SUn, the sustain discharge is continuously generated in the discharge cell in which the address discharge has been generated in the address period. Upon completion of the predetermined number of applications of sustain pulse voltage Vs (V), a sustain operation during the sustain period is completed.

The operations during the initializing period, address period and sustain period in the subsequent second sub-field or later are virtually the same as those of the first sub-field. Therefore, the detailed description thereof will be omitted. Additionally, in the sub-field of the second sub-field or later, sustain electrodes SU1 to SUn are retained at positive voltage Ve1 (V). A ramp voltage that gradually falls from voltage Vi3 (V) to voltage Vi4 (V) is applied to scan electrodes SC1 to SCn. Then, only in the discharge cell in which the sustain discharge has been generated in the prior sub-field, a weak initializing discharge can be generated. That is, in the first sub-field, an entire cell initializing operation to generate an initializing discharge in all of the discharge cells is carried out. In the second sub-field or later, a selective initializing operation to selectively generate the initializing discharge only in the discharge cell in which the sustain discharge has been generated in the prior sub-field is carried out. Additionally, in the present exemplary embodiment, with respect to the entire cell initializing operation and the selective initializing operation, those operations are used separately between the first sub-field and the other sub-fields. However, the entire cell initializing operation may be carried out in the initializing period in sub-fields other than the first sub-field. Moreover, the entire cell initializing operation may be carried out at a frequency of once every several fields.

Moreover, the operations during the address period and the sustain period are the same as those in the above-mentioned first sub-field. However, the operation during the sustain period is not necessarily the same as that in the first sub-field. In order to generate such a sustain discharge as to obtain luminance corresponding to an image signal sig, the number of sustain discharge pulse Vs (V) is changed. That is, the sustain period is driven so as to control the luminance for each sub-field.

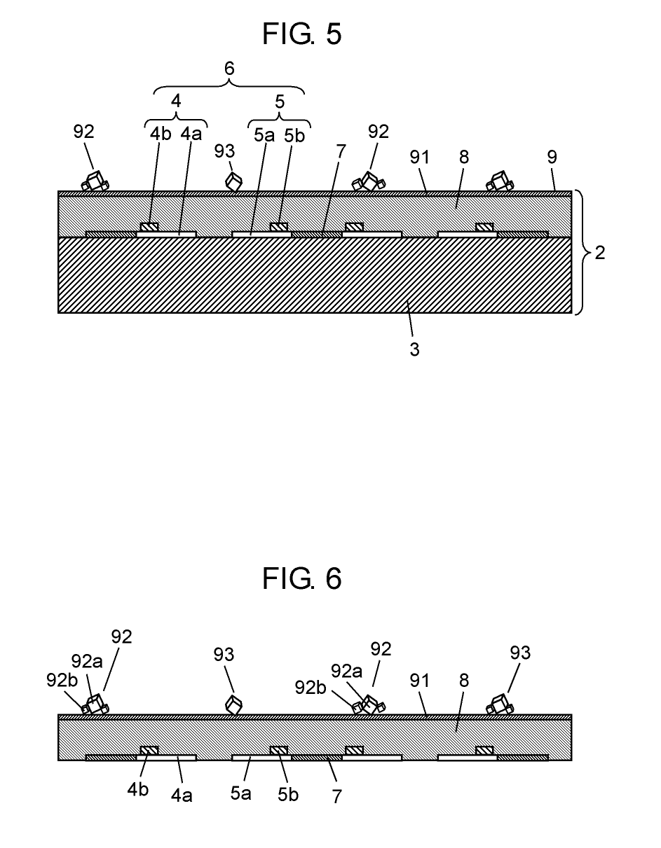

The following description will discuss the configuration of the present exemplary embodiment in detail. As shown in FIG. 5, on front glass substrate 3, a plurality of rows of paired belt-shaped display electrodes 6, each composed of scan electrode 4 and sustain electrode 5, and black stripes 7 are arranged in parallel with each other. Dielectric layer 8 serving as a capacitor is formed on front glass substrate 3 so as to cover display electrodes 6 and black stripes 7. Moreover, protective layer 9 composed of magnesium oxide (MgO) or the like is formed on a surface of dielectric layer 8.

Each of scan electrode 4 and sustain electrode 5 has a structure in which a bus electrode containing Ag is stacked on a transparent electrode composed of a conductive metal oxide such as an indium tin oxide (ITO), a tin oxide (SnO₂), or a zinc oxide (ZnO).

The following description will discuss a method for manufacturing a PDP. Scan electrode 4, sustain electrode 5 and black stripe 7 are formed on front glass substrate 3 by a photolithography method. Scan electrode 4 and sustain electrode 5 have white electrode 4b and white electrode 5b containing silver (Ag) for ensuring conductivity, respectively. Moreover, scan electrode 4 and sustain electrode 5 have transparent electrode 4a and transparent electrode 5a, respectively. White electrode 4b is stacked on transparent electrode 4a. White electrode 5b is stacked on transparent electrode 5a.

As a material for transparent electrodes 4a and 5a, ITO or the like is used so as to ensure transparency and electric conductivity. First, an ITO thin film is formed on front glass substrate 3 by a sputtering method. Then, transparent electrodes 4a and 5a are formed into predetermined patterns by a photolithography method.

As a material for white electrodes 4b and 5b, a white paste containing silver (Ag), a glass frit to bind the silver, a photosensitive resin, a solvent, and the like is used. First, the white paste is applied onto front glass substrate 3 by a screen printing method or the like. Then, the solvent is removed from the white paste in a baking oven. Then, the white paste is exposed to light through a photo-mask having a predetermined pattern.

Then, the white paste is developed so that a white electrode pattern is formed. Finally, the white electrode pattern is fired at a predetermined temperature in a baking oven. In other words, the photosensitive resin is removed from the white electrode pattern. Moreover, the glass frit in the white electrode pattern is melt and re-solidified. Through the above-mentioned steps, white electrodes 4b and 5b are formed.

Black stripe 7 is made of a material containing a black pigment. Then, dielectric layer 8 is formed. As a material for dielectric layer 8, a dielectric paste containing a dielectric glass frit, a resin, a solvent, and the like is used. First, the dielectric paste is applied onto front glass substrate 3 by a die coating method or the like with a predetermined thickness in a manner so as to cover scan electrode 4, sustain electrode 5 and black stripe 7. Then, the solvent is removed from the dielectric paste in a baking oven. Finally, the dielectric paste is fired at a predetermined temperature in a baking oven. In other words, the resin is removed from the dielectric paste. Moreover, the dielectric glass frit is melt and re-solidified. Through the above-mentioned steps, dielectric layer 8 is formed. Here, the dielectric paste may be applied by a screen coating method, a spin coating method or the like other than the die coating method. Moreover, without using the dielectric paste, a film used as dielectric layer 8 can be formed by a CVD (Chemical Vapor Deposition) method, or the like.

Then, protective layer 9 is formed on dielectric layer 8. Protective layer 9 will be described later in detail.

Through the above-mentioned steps, scan electrode 4, sustain electrode 5, black stripe 7, dielectric layer 8 and protective layer 9 are formed on front glass substrate 3 so that front plate 2 is completed.

Data electrode 12 is formed on rear glass substrate 11 by a photolithography method. As a material for data electrode 12, a data electrode paste containing silver (Ag) for ensuring conductivity, a glass frit to bind the silver, a photosensitive resin, a solvent, and the like is used. First, the data electrode paste is applied onto rear glass substrate 11 with a predetermined thickness by a screen printing method or the like. Then, the solvent is removed from the data electrode paste in a baking oven. Then, the data electrode paste is exposed to light through a photo-mask having a predetermined pattern. Then, the data electrode paste is developed so that a data electrode pattern is formed. Finally, the data electrode pattern is fired at a predetermined temperature in a baking oven. In other words, the photosensitive resin is removed from the data electrode pattern. Moreover, the glass frit in the data electrode pattern is melt and re-solidified. Through the above-mentioned steps, data electrode 12 is formed. Here, the data electrode paste may be applied by a sputtering method, a vapor deposition method or the like other than the screen printing method.

Then, base dielectric layer 13 is formed. As a material for base dielectric layer 13, an base dielectric paste containing a dielectric glass frit, a resin, a solvent, and the like is used. First, the base dielectric paste is applied onto rear glass substrate 11, on which data electrode 12 has been formed, with a predetermined thickness in a manner so as to cover data electrodes 12 by a screen printing method or the like. Then, the solvent is removed from the base dielectric paste in a baking oven. Finally, the base dielectric paste is fired at a predetermined temperature in a baking oven. In other words, the resin is removed from the base dielectric layer. Moreover, the dielectric glass frit is melt and re-solidified. Through the above-mentioned steps, base dielectric layer 13 is formed. Here, the base dielectric paste may be applied by a die coating method, a spin coating method, or the like other than the screen printing method. Moreover, without using the base dielectric paste, a film used as base dielectric layer 13 can be formed by a CVD (Chemical Vapor Deposition) method, or the like.

Then, barrier rib 14 is formed by a photolithography method. As a material for barrier rib 14, a barrier rib paste containing filler, a glass frit to bind the filler, a photosensitive resin, a solvent, and the like is used. First, the barrier rib paste is applied onto base dielectric layer 13 with a predetermined thickness by a die coating method or the like. Then, the solvent is removed from the barrier rib paste in a baking oven. Then, the barrier rib paste is exposed to light through a photo-mask having a predetermined pattern. Then, the barrier rib paste is developed so that a barrier rib pattern is formed. Finally, the barrier rib pattern is fired at a predetermined temperature in a baking oven. In other words, the photosensitive resin is removed from the barrier rib pattern. Moreover, the glass frit in the barrier rib pattern is melt and re-solidified. Through the above-mentioned steps, barrier rib 14 is formed. Here, a sand blasting method or the like may be used other than the photolithography method.

Then, phosphor layer 15 is formed. As a material for phosphor layer 15, a phosphor paste containing phosphor particles, a binder, a solvent, and the like is used. First, the phosphor paste is applied onto base dielectric layer 13 between adjacent barrier ribs 14 as well as a side face of barrier rib 14 with a predetermined thickness by a dispensing method or the like. Then, the solvent is removed from the phosphor paste in a baking oven. Finally, the phosphor paste is fired at a predetermined temperature in a baking oven. In other words, the resin is removed from the phosphor paste. Through the above-mentioned steps, phosphor layer 15 is formed. Here, a screen printing method or the like may be used other than the dispensing method.

Through the above-mentioned steps, rear plate 10 having predetermined constituent members is completed on rear glass substrate 11.

Then, front plate 2 and rear plate 10 are assembled. First, a sealing material (not shown) is formed on the periphery of rear plate 10 by a dispensing method. As a material for the sealing material (not shown), a sealing paste containing a glass frit, a binder, a solvent, and the like is used. Then, the solvent is removed from the sealing paste in a baking oven. Then, front plate 2 and rear plate 10 are arranged so as to be opposed to each other such that display electrode 6 and data electrode 12 are orthogonal to each other. Then, the peripheries of front plate 2 and rear plate 10 are sealed with a glass frit. Finally, by sealing a discharge gas containing Ne, Xe, or the like in discharge space 16, PDP 1 is completed.

The following description will discuss dielectric layer 8 in detail. A dielectric material contains the following components: 20% by weight to 40% by weight of bismuth oxide (Bi₂O₃); 0.5% by weight to 12% by weight of at least one material selected from calcium oxide (CaO), strontium oxide (SrO) and barium oxide (BaO); 0.1% by weight to 7% by weight of at least one material selected from molybdenum oxide (MoO₃), tungsten oxide (WO₃), cerium oxide (CeO₂) and manganese dioxide (MnO₂); 0% by weight to 40% by weight of zinc oxide (ZnO); 0% by weight to 35% by weight of boron oxide (B₂O₃); 0% by weight to 15% by weight of silicon dioxide (SiO₂); and 0% by weight to 10% by weight of aluminum oxide (Al₂O₃). The dielectric material substantially contains no lead component.

Moreover, a film thickness of dielectric layer 8 is 40 μm or less. Dielectric constant ∈ of dielectric layer 8 is 4 or more and 7 or less. An effect obtained by setting the dielectric constant ∈ of dielectric layer 8 to 4 or more and 7 or less will be described later.

A dielectric material containing the composition components is pulverized by a wet-type jet mill or ball mill into particles having an average particle diameter of 0.5 μm to 2.5 μm so that a dielectric material powder is produced. Then, 55% by weight to 70% by weight of the dielectric material powder and 30% by weight to 45% by weight of a binder component are sufficiently kneaded by three rolls so that a paste for a first dielectric layer for die coating or for printing is completed.

A binder component is ethyl cellulose, terpineol containing 1% by weight to 20% by weight of acrylic resin, or butyl carbitol acetate. Moreover, to the paste, if necessary, dioctyl phthalate, dibutyl phthalate, triphenyl phosphate, or tributyl phosphate may be added as a plasticizer, and glycerol monoolate, sorbitan sesquioleate, Homogenol (product name, Kao Corporation), a phosphate of alkyl allyl group or the like may be added as a dispersing agent. When the dispersing agent is added thereto, printing properties are improved.

Then, the following description will discuss the configuration of and a manufacturing method for protective layer 9. As shown in FIG. 6, protective layer 9 includes base film 91 serving as a base layer, aggregated particles 92 serving as first particles and crystal particles 93 serving as second particles. Base film 91 is, for example, a magnesium oxide (MgO) film containing aluminum (Al) as an impurity. Aggregated particle 92 is made such that a plurality of crystal particles 92b each having a particle diameter smaller than that of crystal particle 92a are aggregated on MgO crystal particle 92a. Crystal particle 93 is an MgO crystal particle having a cubic shape. The shape can be confirmed with a scanning electron microscope (SEM). In the present exemplary embodiment, a plurality of aggregated particles 92 is dispersed over the entire surface of base film 91 so that it is distributed thereon. A plurality of crystal particles 93 is dispersed over the entire surface of base film 91 so that it is distributed thereon.

Crystal particles 92a are particles having an average particle diameter in a range of 0.9 μm to 2 μm. Crystal particles 92b are particles having an average particle diameter in a range of 0.3 μm to 0.9 μm. In the present exemplary embodiment, the average particle diameter refers to a cumulative volume mean diameter (D50). Moreover, the average particle diameter was measured by using a laser diffraction particle size distribution analyzer MT-3300 (manufactured by NIKKISO CO., LTD.).

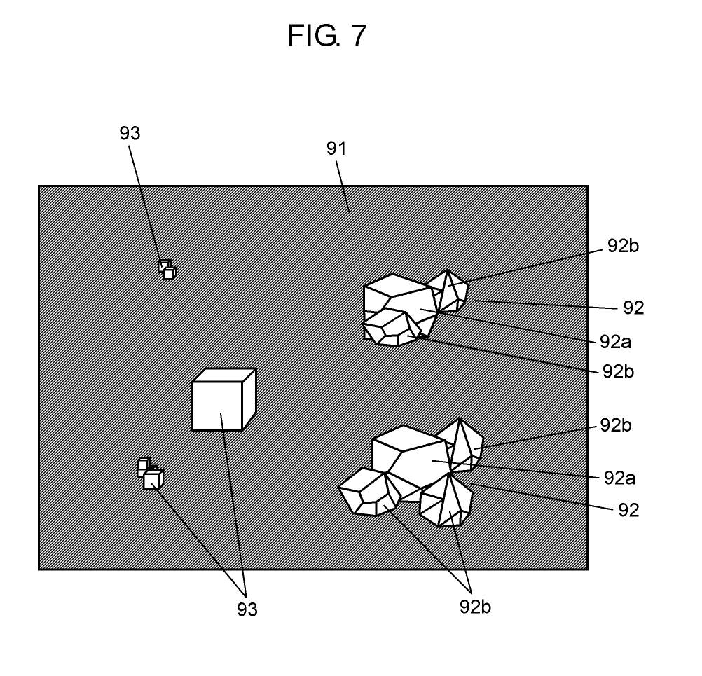

As shown in FIG. 7, on the surface of protective layer 9, aggregated particles 92 each obtained by aggregating several crystal particles 92b each having a polyhedral shape on crystal particle 92a having a polyhedral shape and crystal particle 93 having a cubic shape are dispersed over base film 91 so that they are distributed thereon. Crystal particle 93 having a cubic shape includes particles each having a particle diameter of about 200 nm and particles each having a nano particle diameter of 100 nm or less. Actual observations of PDP 1 indicate that there were crystal particles 93, each having a cubic shape, mutually aggregated with each other, and those particles in which MgO crystal particles 93 each having a cubic shape adhere to crystal particle 92a having a polyhedral shape, or crystal particle 92b having a polyhedral shape, or aggregated particle 92 of crystal particles 92a and 92b each having a polyhedral shape. Moreover, crystal particles 92a and 92b each having a polyhedral shape were produced by a liquid-phase method. Crystal particle 93 having a cubic shape was produced by a vapor-phase method.

It should be noted that the “cubic shape” does not mean a strictly-speaking cube in terms of geometry. It means a shape that is approximately recognized as a cube when visually observing electron microscopic photographs. Additionally, the “polyhedral shape” refers to a shape that is recognized as having about seven or more surfaces when visually observing electron microscopic photographs.

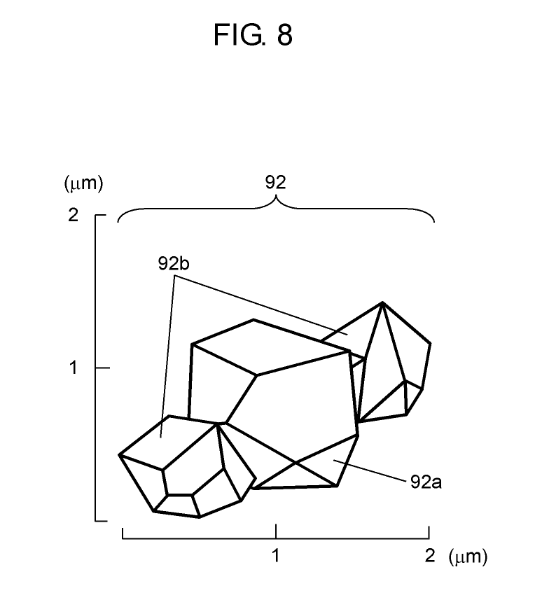

As shown in FIG. 8, aggregated particle 92 refers to a particle such that a plurality of crystal particles 92a and 92b each having a predetermined primary particle diameter are aggregated. Aggregated particles 92 are not bonded with each other by a strong binding force as a solid substance. Aggregated particle 92 is obtained by aggregating a plurality of primary particles by static electricity, van der Waals force, or the like. Moreover, aggregated particles 92 are bonded with each other by an external force such as an ultrasonic wave so that one portion or entire portion of the particles is decomposed into a primary particle state. A particle diameter of aggregated particle 92 is about 1 μm, and each of crystal particles 92a and 92b has a polyhedral shape with seven or more surfaces such as a tetradecahedron or a dodecahedron. Moreover, crystal particles 92a and 92b were formed by a liquid-phase method that generates them by firing a solution of an MgO precursor such as magnesium carbonate or magnesium hydroxide. The particle diameters can be controlled by adjusting a firing temperature or firing atmosphere in the liquid-phase method. The firing temperature can be selected from a range of about 700° C. to about 1500° C. In the case of the firing temperature of 1000° C. or higher, the primary particle diameter can be controlled to about 0.3 μm to 2 μm. During the generation process in the liquid-phase method, crystal particles 92a and 92b are obtained as aggregated particles 92 in which a plurality of primary particles is aggregated with each other.

On the other hand, crystal particle 93 having a cubic shape is obtained by a vapor-phase method in which magnesium is heated to its boiling point or higher to generate a magnesium vapor to carry out vapor-phase oxidation. A crystal particle having a single crystal structure with a cubic shape having a particle diameter of 200 nm or more (measurement result of a BET method) and a crystal particle having a multiple crystal structure with crystals being mutually fitted to each other are obtained. With respect to a method of synthesizing a magnesium powder by this vapor-phase method, for example, “Synthesis of Magnesia Powder by Vapor Phase Method and Properties thereof”, Vol. 36, No. 410, Journal of “Materials” and the like are known.

When a crystal particle having a single crystal structure with a cubic shape having an average particle diameter of 200 nm or more is formed, a heating temperature at the time of generating a magnesium vapor is raised, and the length of a flame for reacting magnesium with oxygen is made longer. By making a temperature difference between the flame and the ambient temperature greater, an MgO crystal particle having a greater particle diameter is obtained by the vapor phase method.

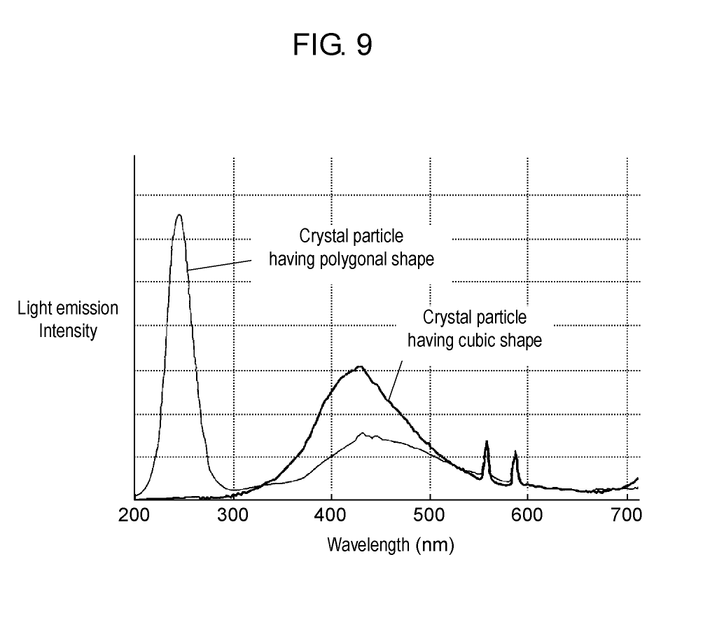

With respect to crystal particles 92a and 92b each having a polyhedral shape and crystal particle 93 having a cubic shape, cathode luminescence (CL) emission characteristics were measured. As shown in FIG. 9, the emission intensities of MgO crystal particles 92a and 92b each having a polyhedral shape, that is, the cathode luminescence (emission) intensity of aggregated particle 92 is indicated by a thin solid line. The cathode luminescence (emission) intensity of MgO crystal particle 93 having a cubic shape is indicated by a thick solid line.

As shown in FIG. 9, aggregated particle 92 obtained by aggregating several crystal particles 92a and 92b each having a polyhedral shape has an emission intensity peak in a wavelength region from a wavelength of 200 nm or more to 300 nm or less, in particular, a wavelength of 230 nm or more to 250 nm or less. MgO crystal particle 93 having a cubic shape does not have an emission intensity peak in a wavelength region from a wavelength of 200 nm or more to 300 nm or less. However, crystal particle 93 has an emission intensity peak in a wavelength region from a wavelength of 400 nm or more to 450 nm or less. In other words, aggregated particle 92 allowed to adhere to base film 91 and obtained by aggregating several MgO crystal particles 92a and 92b each having a polyhedral shape and MgO crystal particle 93 having a cubic shape have energy levels corresponding to the wavelengths of the emission intensity peaks, respectively.

The following description will discuss results of experiments carried out so as to confirm the effects of a PDP having the protective layer of the present exemplary embodiment.

First, PDPs with protective layers having different configurations were produced experimentally. Sample 1 is a PDP on which only an MgO protective layer is formed. Sample 2 is a PDP on which a protective layer made of MgO doped with an impurity such as Al or Si is formed. Sample 3 is a PDP on which only primary particles of crystal particles made of a metal oxide are dispersed on a protective layer made of MgO to adhere thereto. Sample 4 is a PDP in which aggregated particles 92 obtained by aggregating MgO crystal particles having equal particle diameters with each other adhere to a base film made of MgO so that they are distributed over the entire surface of the base film. Sample 5 is a PDP in accordance with the present exemplary embodiment. The PDP has a configuration in which aggregated particles 92 each having a polyhedral shape obtained by aggregating MgO crystal particles 92b each having a particle diameter smaller than that of crystal particles 92a on the periphery of MgO crystal particles 92a having an average particle diameter in a range of 0.9 μm to 2 μm, and MgO crystal particle 93 having a cubic shape adhere to base film 91 made of MgO so that they are distributed over the entire surface thereof. That is, Sample 5 is a PDP in which a plurality of aggregated particles 92 and a plurality of crystal particles 93 are dispersed over the entire surface of base film 91 so that they are distributed thereon. Additionally, a PDP in which a plurality of aggregated particles 92 and a plurality of crystal particles 93 are uniformly dispersed over the entire surface of base film 91 so that they are distributed thereon is more preferable. The reason for this is because a fluctuation in discharging characteristic in a plane of PDP can be suppressed.

With respect to these PDPs having the configurations of the protective layer of five types, electron emission performance and electric charge retention performance were measured.

The electron emission performance is a value that is shown to increase as an electron emission amount becomes larger. The electron emission performance is expressed as an initial electron emission amount determined by a surface state of the discharge, a type of gas, and the state of gas. The initial electron emission amount can be measured by a method in which the surface is irradiated with an ion or electron beam and an electronic current amount emitted from the surface is measured. However, this method is difficult to carry out in a nondestructive way. For this reason, a method disclosed in JP-A No. 2007-48733 was utilized. In other words, among delay times at the time of discharge, a numeric value which provides an indication of ease of discharge generation, called a statistical delay time, was measured. By integrating an inverse number of the statistical delay time, a numeric value that lineally corresponds to the emission amount of the initial electrons is obtained. The delay time at the time of discharge refers to a period of time from rising of the address discharge pulse until the address discharge is generated later. It is considered that the discharge delay is mainly caused by the fact that the initial electron serving as a trigger upon generation of the address discharge is hardly emitted from the surface of the protective layer to the discharge space.

Moreover, the electric charge retention performance uses, as its index, a voltage value of a voltage (hereinafter, referred to as a “Vscn lighting voltage”) to be applied to the scan electrode, which is required for suppressing an electric charge emission phenomenon when produced as a PDP. That is, the lower the Vscn lighting voltage is, the higher the electric charge retention capability is. When the Vscn lighting voltage is low, the PDP can be driven at a low voltage. Consequently, as a power supply, various electric parts, and the like, those parts having a small breakdown voltage and a small capacity can be used. In current products, as a semiconductor switching element such as a MOSFET for applying a scan voltage to a sequential panel, an element having a breakdown voltage of about 150 V has been used. By taking into consideration variations caused by temperatures, the Vscn lighting voltage is desirably suppressed to 120 V or less.

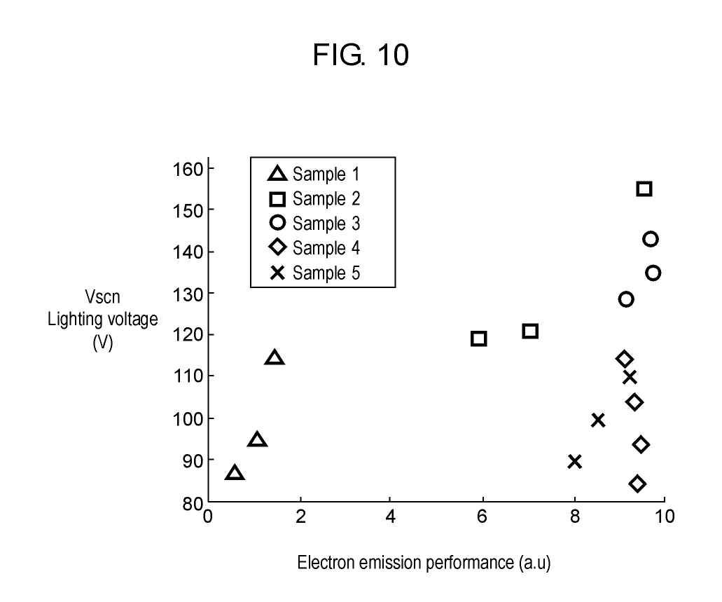

FIG. 10 shows the results of examinations carried out on the electron emission performance and the electric charge retention performance. As is clear from FIG. 10, each of Samples 4 and 5 could make the Vscn lighting voltage 120 V or less in the evaluation of the electric charge retention performance. Each of Samples 4 and 5 could also obtain a preferable characteristic of 6 or more in the electron emission performance.

In general, the electron emission capability and the charge sustaining capability of the protective layer in the PDP are contrary to each other. For example, by changing a condition for forming the protective layer, or doping an impurity such as Al, Si, or Ba in the protective layer, the electron emission performance can be improved. However, the Vscn lighting voltage also rises as an adverse effect.

In the PDP having the protective layer of the present exemplary embodiment, one having a characteristic of 6 or more in the electron emission capability and a characteristic of 120 V or less of the Vscn lighting voltage in the charge retention capability can be obtained. In other words, it becomes possible to obtain a protective layer having both the electron emission capability and the charge retention capability that can cope with a PDP in which the number of scan lines increases due to high definition and the cell size thereof tends to be decreased.

Moreover, in protective layer 9 in accordance with the present exemplary embodiment, base film 91 containing MgO is formed on dielectric layer 8 and a plurality of aggregated particles 92 obtained by aggregating a plurality of crystal particles made of MgO serving as a metal oxide, and a plurality of crystal particles 93 each having a cubic shape and made of MgO serving as a metal oxide are dispersed over the entire surface of base film 91 so that they are distributed thereon, and a Si concentration in base film 91 is set to 10 ppm or less.

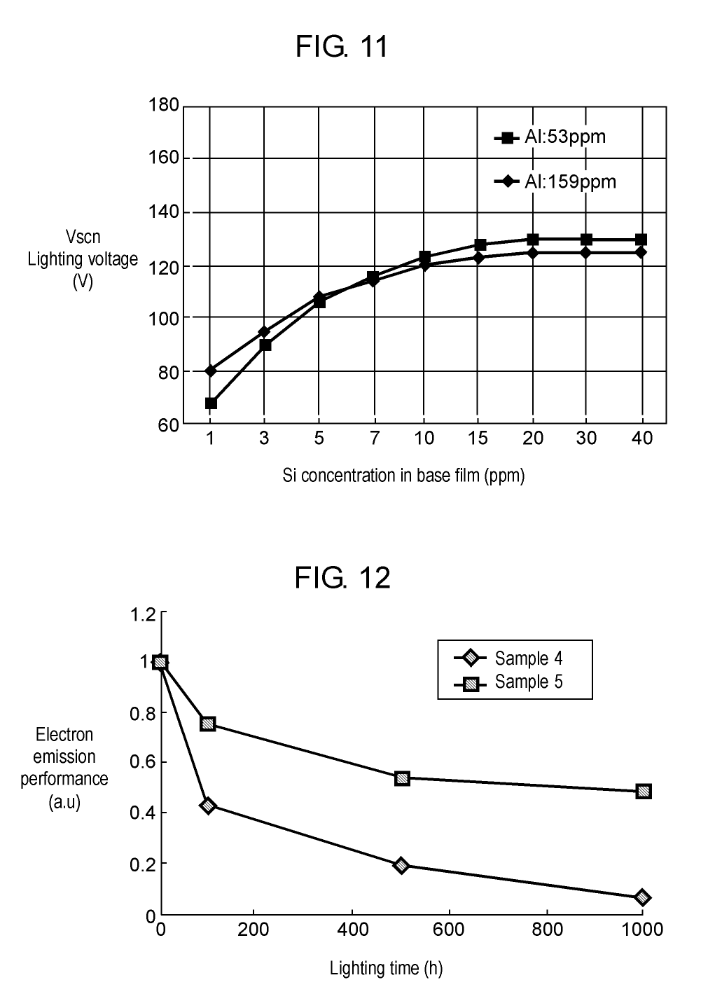

As shown in FIG. 11, in the configuration of protective layer 9 in the present exemplary embodiment, the Vscn lighting voltage is changed depending on the Si concentration in base film 91. Moreover, the Vscn lighting voltage is not dependent on an Al concentration in base film 91. When the Si concentration exceeds 10 ppm, the Vscn lighting voltage tends to become virtually a saturated state. Consequently, the Vscn lighting voltage can be set to 120 V or less. Therefore, as the configuration of protective layer 9 to reduce the Vscn lighting voltage, a configuration is proposed in which a plurality of aggregated particles 92 obtained by aggregating a plurality of crystal particles made of MgO, and a plurality of crystal particles 93 each having a cubic shape and made of MgO are dispersed over the entire surface of base film 91 containing MgO so that they are distributed thereon, with a Si concentration in base film 91 being set to 10 ppm or less. Moreover, in order to lower the Vscn lighting voltage to 110 V or less, the Si concentration in base film 91 is desirably set to 5 ppm or less.

The following description will discuss the results of examinations for a change with time in the electron emission performance of protective layer 9. In order to prolong the life of a PDP, the electron emission performance of protective layer 9 is required not to be deteriorated with time.

As the results of examinations for deterioration with time of the electron emission performance of Samples 4 and 5 that have preferable characteristics as shown in FIG. 10, FIG. 12 shows the transition of the electron emission performance with respect to a lighting time of the PDP. As shown in FIG. 12, Sample 5 in which aggregated particles 92 each having a polyhedral shape obtained by aggregating MgO crystal particles 92b each having a particle diameter smaller than that of crystal particles 92a on the periphery of MgO crystal particles 92a having an average particle diameter in a range of 0.9 μm to 2 μm, and MgO crystal particle 93 having a cubic shape are dispersed over the entire surface of base film 91 made of MgO so that they are distributed thereon shows less deterioration with time of the electron emission performance in comparison with that of Sample 4.

In Sample 4, it is estimated that ions generated by a discharge in a PDP cell impact the protective layer to peel aggregated particles 92. On the other hand, in Sample 5, on the periphery of MgO crystal particles 92a having an average particle diameter in a range of 0.9 μm to 2 μm, MgO crystal particles 92b each having a further smaller average particle diameter are aggregated. In other words, it is estimated that, since crystal particles 92b having a smaller particle diameter has a larger surface area, adhesion properties to base film 91 are improved and aggregated particle 92 is rarely peeled due to ion impacts.

In the PDP of Sample 5, it becomes possible to obtain one having a characteristic of 6 or more in the electron emission capability and a characteristic of 120 V or less of the Vscn lighting voltage in the electric charge retention capability can be obtained. In other words, it becomes possible to obtain a protective layer having both the electron emission capability and the electric charge retention capability that can cope with a PDP in which the number of scan lines increases due to high definition and the cell size thereof tends to be decreased. Moreover, since the deterioration with time of the electron emission performance is small, stable image quality can be obtained for a long period of time.

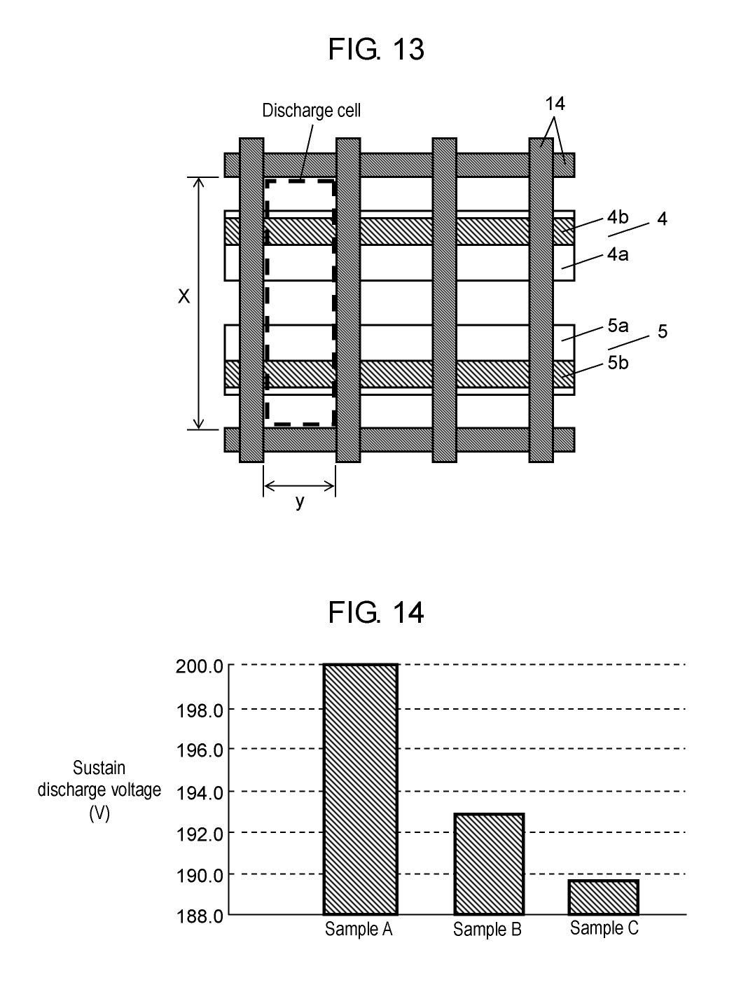

In the present exemplary embodiment, when aggregated particle 92 and crystal particle 93 are allowed to adhere onto base film 91, aggregated particle 92 and crystal particle 93 adhere with a coverage in a range of 10% or more and 20% or less so as to be distributed over the entire surface of base film 91. The coverage, in a region of one discharge cell, area “a” to which aggregated particle 92 and crystal particle 93 adhere, is expressed by a ratio of area “b” of one discharge cell and is calculated by an equation: coverage (%)=a/b×100. For example, as shown in FIG. 13, in an actual measuring method, an image of a region corresponding to one discharge cell partitioned by barrier rib 14 is photographed. Then, the image is trimmed into a size of one cell of x×y. Then, the image that has been trimmed is binarized into black-and-white data. Then, based on the binarized data, area “a” of a black area derived from aggregated particles 92 and crystal particles 93 is calculated. Finally, calculations are carried out based on the expression a/b×100.

Then, in order to confirm the effects of a PDP having a protective layer to which crystal particles 92a and 92b each having a polyhedral shape and crystal particle 93 having a cubic shape are allowed to adhere, Samples were further produced, and a sustain discharge voltage was examined. As shown in FIG. 14, Sample A is a PDP in which only aggregated particles 92 made of MgO crystal particles 92a and 92b each having a CL emission peak in a wavelength region from 200 nm or more to 300 nm or less are dispersed on base film 91 made of MgO so that they adhere thereto. Each of Samples B and C is a PDP in which aggregated particles 92 obtained by aggregating MgO crystal particles 92b each having a polyhedral shape and a particle diameter smaller than that of crystal particles 92a on the periphery of MgO crystal particle 92a having an average particle diameter in a range of 0.9 μm to 2 μm, and MgO crystal particle 93 having a cubic shape are dispersed over the entire surface of a base film made of MgO so that they are distributed thereon. Sample B and Sample C are different from each other in a dielectric constant ∈ of dielectric layer 8. In other words, Sample B has a dielectric constant ∈ of dielectric layer 8 of about 9.7. Sample C has a dielectric constant ∈ of dielectric layer 8 of 7. A coverage of each of them is about 13% that is less than 20%.

As shown in FIG. 14, the sustain discharge voltages of Samples B and C can be made lower than that of Sample A. That is, a PDP having a protective layer to which aggregated particles 92 having MgO crystal particles 92a and 92b each having a polyhedral shape including characteristics to conduct CL emission having a peak in a wavelength region from 200 nm or more to 300 nm or less and MgO crystal particle 93 having a cubic shape including characteristics to conduct CL emission having a peak in a wavelength region from 400 nm or more to 450 nm or less adhere, makes it possible to decrease the sustain discharge voltage. That is, it is possible to achieve a low power consumption of the PDP. Moreover, as is clear from the characteristics of Samples B and C, it becomes possible to further reduce the sustain discharge voltage as the dielectric constant ∈ of dielectric layer 8 is made smaller. In particular, according to an experiment by the present inventors, it has been found that more remarkable effects can be obtained by setting the dielectric constant ∈ of dielectric layer 8 to 4 or more and 7 or less.

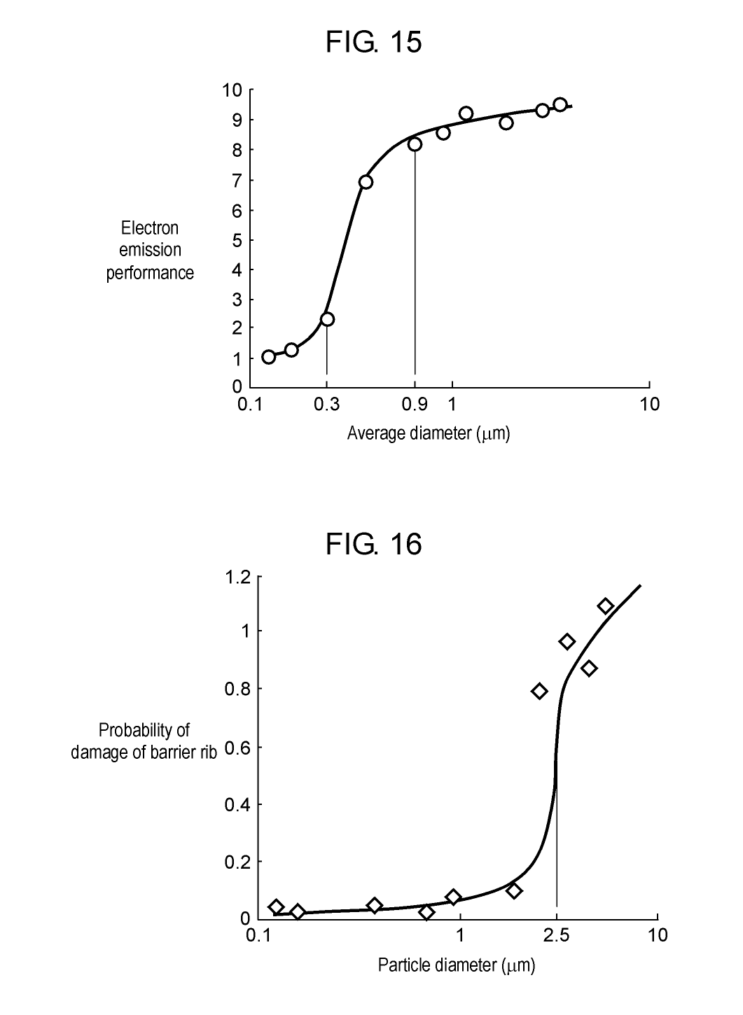

FIG. 15 shows an experiment result obtained by changing average particle diameters of MgO aggregated particles 92 in the protective layer and examining electron emission performance. In FIG. 15, the average particle diameter of aggregated particles 92 is measured by SEM observation of aggregated particles 92.

As shown in FIG. 15, when the average particle diameter becomes smaller to about 0.3 μm, the electron emission performance is lowered, while when it is about 0.9 μm or more, high electron emission performance can be obtained.

In order to increase the number of electrons emitted in a discharge cell, the number of crystal particles per unit area on protective layer 9 is desirably large. According to the experiment by the present inventors, when crystal particles 92a, 92b and 93 are present in a portion corresponding to the top portion of barrier rib 14 that is in close contact with protective layer 9, the top portion of barrier rib 14 may be damaged. It has been found that in such a case, due to a damaged material of barrier rib 14 being placed on a phosphor or the like, a phenomenon in which the corresponding cell fails to be normally turned on or off occurs. Since the phenomenon in which the barrier rib is damaged does not easily occur unless crystal particles 92a, 92b and 93 are present in a portion corresponding to the top portion of the barrier rib, the probability of occurrence of damage in barrier rib 14 becomes higher as the number of crystal particles that are allowed to adhere is increased.

FIG. 16 is a graph showing the results of experiments in which in a PDP, by dispersing the same number of crystal particles having different particle diameters per unit area, a relationship thereof with damaged barrier ribs is examined.

As shown in FIG. 16, when the particle diameter becomes large about 2.5 μm, the probability of damage of the barrier rib becomes abruptly higher. However, it is found that when the particle diameter is smaller than 2.5 μm, the probability of damage of the barrier rib can be suppressed to a comparatively small level.

Based on the results described above, it is considered that aggregated particles 92 desirably have an average particle diameter of 0.9 μm or more and 2.5 μm or less. When the PDPs are actually mass-produced, it is necessary to take into consideration a fluctuation in manufacture of crystal particles and a fluctuation in manufacture when a protective layer is formed.

In order to take factors such as the fluctuations in manufacture into consideration, experiments are carried out by using crystal particles having different particle diameter distributions, and as a result, it has been found that by using aggregated particles 92 having an average particle diameter in a range of 0.9 μm to 2 μm, the above-mentioned effects can be stably obtained.

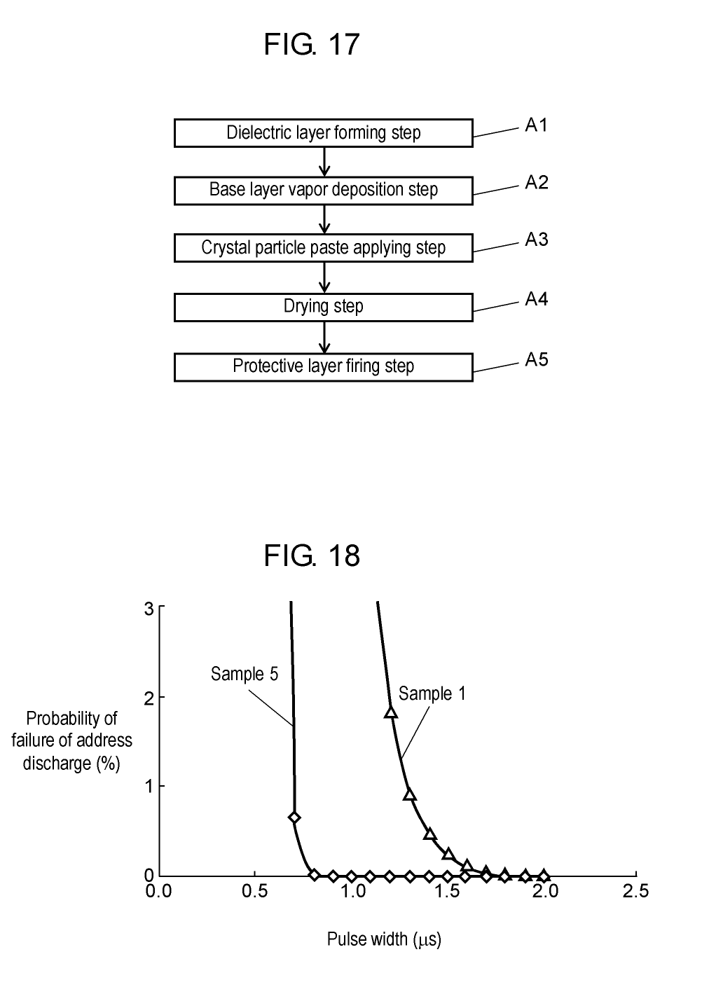

Then, with reference to FIG. 17, the following description will discuss a manufacturing step for forming protective layer 9 in the PDP of the present exemplary embodiment.

As shown in FIG. 17, after carrying out dielectric layer forming step A1 for forming dielectric layer 8, in base film vapor-deposition step A2, base film 91 made of MgO containing Al as an impurity is formed on dielectric layer 8 by a vacuum vapor deposition method using, as a raw material, an MgO sintered body containing Al.

Thereafter, on unfired base film 91, a plurality of aggregated particles 92 and a plurality of crystal particles 93 are discretely dispersed and allowed to adhere. That is, aggregated particles 92 and crystal particles 93 are dispersed over the entire surface of base film 91 so that they are distributed thereon.

In this step, first, an aggregated particle paste obtained by mixing crystal particles 92a and 92b each having a polyhedral shape and a predetermined particle diameter distribution with a solvent is produced. Moreover, a crystal particle paste obtained by mixing crystal particles 93 each having a cubic shape with a solvent is produced. In other words, the aggregated particle paste and the crystal particle paste are prepared separately. Thereafter, by mixing the aggregated particle paste and the crystal particle paste with each other, a mixed crystal particle paste obtained by mixing crystal particles 92a and 92b each having a polyhedral shape and crystal particles 93 with a solvent is produced. Then, in crystal particle paste applying step A3, the mixed crystal particle paste is applied onto base film 91 so that a mixed crystal particle paste film having an average film thickness of 8 μm to 20 μm is formed thereon. As a method for applying the mixed crystal particle paste onto base film 91, a screen printing method, a spraying method, a spin coating method, a die coating method, a slit coating method, or the like can also be used.

As the solvent to be used to produce the aggregated particle paste and the crystal particle paste, those solvents are suitable which have high affinity to MgO base film 91, aggregated particle 92 and crystal particle 93, and also have a vapor pressure of about several tens of Pa at normal temperature so as to easily remove a vapor in drying step A4 that is the next step. Examples thereof include a single substance of an organic solvent such as methyl methoxy butanol, terpineol, propylene glycol, or benzyl alcohol, or a mixture solvent thereof. A viscosity of the paste containing these solvents is several m Pa·s second to several tens of m Pa·s.

A substrate to which the mixed crystal particle paste has been applied is immediately transferred to drying step A4. In drying step A4, the mixed crystal particle paste film is dried at a reduced pressure. More specifically, the mixed crystal particle paste film is quickly dried in a vacuum chamber within several tens of seconds. Therefore, convection in the film that is conspicuous in heat-drying does not occur. Thus, aggregated particle 92 and crystal particle 93 more uniformly adhere onto base film 91. As a drying method in drying step A4, a heat-drying method may be used depending on the solvent and the like used in production of the mixed crystal particle paste.

Then, in protective layer firing step A5, unfired base film 91 formed in base film vapor deposition step A2 and the mixed crystal particle paste film having been subjected to drying step A4 are simultaneously fired a temperature of several hundred ° C. By the firing, the solvent and resin components remaining in the mixed crystal particle paste are removed. As a result, protective layer 9 to which aggregated particles 92 including a plurality of crystal particles 92a and 92b each having a polyhedral shape and crystal particle 93 having a cubic shape adhere is formed.

According to this method, aggregated particles 92 and crystal particles 93 can be dispersed over the entire surface of base film 91 so that they are distributed thereon.

In addition to this method, a method of directly spraying a particle group together with a gas without using a solvent or the like, a method of dispersing particles by simply using the gravity, or the like may be used.

It should be noted that MgO is illustrated as a protective layer as an example in the above description. However, the performance required for the base film is to have higher sputter-resistant performance to protect the dielectric layer against ion impacts, and high electric charge retention performance, that is, high electron emission performance is not necessarily required. In the conventional PDP, a protective layer mainly made of MgO is formed in many cases in order to achieve a certain level of the electron emission performance and the sputter-resistant performance; however, since a configuration in which the electron emission performance is dominantly controlled by metal oxide single crystal particles is adopted, use of MgO is not required any more, and another material such as Al₂O₃ that is excellent in impact resistance may be used.

In the present exemplary embodiment, the description has been made with reference to an MgO particle as a single crystal particle; however, even though another single crystal particle or a crystal particle made of an oxide of a metal such as Sr, Ca, Ba, or Al having high electron emission performance like MgO is used, the same effect as described above can be obtained. Consequently, the seed particle is not limited to MgO.

In a PDP, the number of scan lines increases along with high definition; however, upon displaying a television image, all the sequences need to be completed within one field= 1/60 [s]. In the above address period, a pulse width of a pulse voltage to be applied to the data electrode needs to be set to a period of time within which the address discharge can be surely generated. However, in the address discharge, there is a “discharge delay” in which a discharge takes place after a considerable delay from the rise of a pulse voltage applied to the data electrode. Moreover, when an address discharge is not completed within the applied pulse width, a predetermined address voltage is not accumulated in the discharge cell to be originally lighted on so that a phenomenon to cause a failure in lighting on occurs.

FIG. 18 is a graph on which, during an address period, the pulse width of a pulse voltage to be applied to a data electrode and the probability of failure of an address discharge are plotted, with respect to PDPs using the front plates of Sample 1 and Sample 5. As shown in FIG. 18, in Sample 1 having only the base film made of MgO, a pulse width with 1.7 μs or more is required so as to suppress a failure in the address discharge. On the other hand, in Sample 5, it is possible to set the pulse width to 1 μs or less.

As described above, during the address period, by shortening the pulse width of the pulse voltage to be applied to the data electrode, the period of time required for the address period can be shortened. As a result, the sustain period can be prolonged. Therefore, more sustain pulses can be applied so that the luminance of the PDP can be improved.

In accordance with the PDP disclosed in the present exemplary embodiment, both an improvement in discharge delay characteristic and a low voltage at the time of address discharge can be achieved. Moreover, the discharge voltage at the time of sustain discharge can be reduced.

### INDUSTRIAL APPLICABILITY

As described above, the technique disclosed in the present exemplary embodiment is provided with display performance with high definition and high luminance, and is useful in realizing a PDP with low power consumption.

### REFERENCE MARKS IN THE DRAWINGS

1 PDP
2 Front plate
3 Front glass substrate
4 Scan electrode
4a, 5a Transparent electrode
4b, 5b White electrode
5 Sustain electrode
6 Display electrode
7 Black stripe
8 Dielectric layer
9 Protective layer
10 Rear plate
11 Rear glass substrate
12 Data electrode
13 Base dielectric layer
14 Barrier rib
15 Phosphor layer
16 Discharge space
21 Image signal processing circuit
22 Data electrode drive circuit
23 Scan electrode drive circuit
24 Sustain electrode drive circuit
25 Timing generation circuit
91 Base film
92 Aggregated particles
92a, 92b, 93 Crystal particles
100 Plasma display device

1. A method for manufacturing a plasma display panel provided with a dielectric layer covering display electrodes and a base layer formed on the dielectric layer, comprising:
preparing an aggregated particle paste containing aggregated particles, each composed of a plurality of aggregated crystal particles made of magnesium oxide, and a solvent;
preparing a crystal particle paste containing crystal particles having a cubic shape, made of magnesium oxide, and a solvent;
thereafter, mixing the aggregated particle paste and the crystal particle paste with each other so that a mixed crystal particle paste is prepared;
then, applying the mixed crystal particle paste to form a mixed crystal particle paste film on the base layer; and
thereafter, drying the mixed crystal particle paste film so that the aggregated particles and the crystal particles are dispersed over the entire surface of the base layer.

2. The method for manufacturing a plasma display panel according to claim 1, wherein
the aggregated particles have an average particle size in a range of 0.9 μm or more to 2.0 μm or less.

3. The method for manufacturing a plasma display panel according to claim 1, wherein
each of the crystal particles forming the aggregated particle has a polyhedral shape having seven or more surfaces.

4. The method for manufacturing a plasma display panel according to claim 2, wherein
each of the crystal particles forming the aggregated particle has a polyhedral shape having seven or more surfaces.

5. The method for manufacturing a plasma display panel according to claim 1, wherein
the base layer contains a magnesium oxide.

6. The method for manufacturing a plasma display panel according to claim 2, wherein
the base layer contains a magnesium oxide.

7. The method for manufacturing a plasma display panel according to claim 3, wherein
the base layer contains a magnesium oxide.

8. The method for manufacturing a plasma display panel according to claim 4, wherein
the base layer contains a magnesium oxide.
